(19) United States
(12) Patent Application Publication
(10) Pub. No.: US 2006/0174100 A1
(43) Pub. Date: Aug. 3, 2006

(54) System and method of booting an operating system for a computer

(75) Inventor: Jung-Su Park, Gwacheon-si (KR)

Correspondence Address: F. CHAU & ASSOCIATES, LLC, 130 WOODBURY ROAD, WOODBURY, NY, 11797, US

(73) Assignee: Samsung Electronics Co., LTD, Suwon-si (KR)

(21) Appl. No.: 11/326,083

(22) Filed: Jan. 5, 2006

(30) Foreign Application Priority Data
Jan. 31, 2005 (KR) 2005-8427

(51) Int. Cl. G06F 9/00

(52) U.S. Cl. 713/2

(57) ABSTRACT

A booting system includes a central processing unit (CPU) core, a system bus, a main memory, a boot loader memory device, a first external memory device, a boot logic unit, a second external memory device and an external interface unit. The first external memory stores a boot loader program, which is transferred to the boot loader memory device. An operating system stored in the second external memory unit is transferred to the main memory by an external interface unit, which is controlled by the boot loader program. The first external memory device and the boot logic unit may be excluded, and a ROM may be employed as the boot loader memory device. Therefore, a booting speed may be increased, a number of input and output pins may be reduced, and power consumption may also be reduced.

### CROSS REFERENCE TO RELATED APPLICATIONS

This application claims priority under 35 USC § 119 to Korean Patent Application No. 2005-8427, filed on Jan. 31, 2005, the contents of which are herein incorporated by reference in their entirety.

### BACKGROUND OF THE INVENTION

1. Field of the Invention

The present invention relates to a system and a method of booting an operating system.

2. Description of the Related Art

A booting mechanism is used to initiate or start a computer system. When a computer is powered on, codes and data of an operating system and application programs are loaded from an auxiliary memory device to a main memory so that the operating system may be ready for running and controlling the entire computer system.

The computer system may be a general personal computer or another portable device, such as a personal digital assistant (PDA). The auxiliary memory device has a relatively large storage capacity and a slow access speed. The auxiliary memory device may have characteristics of a non-volatile memory. The main memory may include a random access memory (RAM), which has a higher access speed. The main memory is mapped in an address space of a central processing unit (CPU) of the computer system. In a portable computer system such as a PDA, a flash memory is widely used for the secondary memory unit.

FIG. 1 is a block diagram illustrating a conventional booting system using a flash memory device.

Referring to FIG. 1, the conventional booting system 100 includes a CPU core 111, a system bus 112 coupled to the CPU core 111 and various peripheral devices, a memory controller 113, a system bus interface unit 115, an internal static random access memory (SRAM) 116, a flash memory controller 117, an external interface unit 118, an external flash memory device 120 coupled to the external interface unit 118 through an external interface 119, and a main memory device 130.

In a portable system such as a personal digital assistant (PDA), the elements of the conventional booting system 100 are typically integrated into a system-on-chip (SOC) 110, except for the external flash memory device 120 and the main memory device 130. In addition, a NOR-type flash memory device or a NAND-type flash memory device may be used.

A booting process of the conventional booting system 100 of FIG. 1 proceeds as follows.

When a system is powered on or reset, a boot loader code of a predefined size and data are first loaded into the internal SRAM 116 from the external flash memory device 120 through the external interface unit 118 and the external interface 119, based upon a control of the flash memory controller 117.

The boot loader program is a relatively small program that is executed by the CPU core 111 to transfer codes and data of the operating system and other application programs. The codes and data are transferred from the external flash memory device 120 to the main memory device 130 coupled to a system bus, via the external interface unit 118 and external interface 119. The transfer of the codes and data is carried out based upon the control of the flash memory controller 117.

When the codes and data of the operating system and the application programs are completely loaded to the main memory device 130 by execution of the boot loader program, a program counter of the CPU core 111 is changed to a start address of the operating system so that the operating system may control the entire computer system. The booting process is thereby finished.

According to the conventional booting system 100, when the NAND-type flash memory device is used, a read busy state of the NAND-type flash memory during a page read operation mode may increase the entire booting time because the transfer of the codes and data of the operating system and the application programs is delayed.

The NAND flash memory device typically includes an interface with 16-bit parallel data output, but it is difficult for the data reading speed of the NAND flash memory to reach 20 MB/s. In addition, with the 16-bit parallel data output, a number of input and output pins for interfacing with an external device may be increased when the elements of the booting system 100, except for the external flash memory device 120 and the main memory device 130, are integrated into a system-on-chip 110 as described above.

The increase in the number of input and output pins may cause difficulties in reducing a size of a system, which may include various functional blocks integrated on the system-on-chip. In addition, when the number of input and output pins that are switched by a parallel interface is increased, power consumption of the system may be increased.

The NOR flash memory device having a higher data reading speed than the NAND flash memory device may be used to improve the booting speed. However, the number of the input and output pins, in case of the parallel interface, increase and so does the power consumption.

### SUMMARY OF THE INVENTION

Exemplary embodiments of the present invention provide booting systems, which are flexibly employed for interfacing with an external storage device with a high booting speed.

Other exemplary embodiments of the present invention provide booting methods, which are flexibly employed for interfacing with an external storage device with a high booting speed.

According to an embodiment of the present invention, a booting system includes a central processing unit (CPU) core, a system bus connected to the CPU core, a main memory connected to the CPU core through the system bus, a boot loader memory device connected to the CPU core through the system bus, a first external memory device storing a boot loader program, a boot logic unit transferring the boot loader program from the first external memory device to the boot loader memory device, in which the boot loader program is executed by the CPU core, a second external memory device storing codes and data of an operating system and an application program, and an external interface unit transferring the codes and data of the operating system and the application program from the second external memory device to the main memory, the external interface unit controlled by the boot loader program.

In further embodiments of the present invention, the CPU core, the boot loader memory device, the boot logic unit and the external interface unit may be an integrated system-on-chip. The first external memory device may include a serial electrically erasable programmable read-only memory (EEPROM). An interface between the first external memory device and the boot logic unit may include one of I²C and SPI. The second external memory device may include one of a hard disk and a flash memory device. An interface between the external interface unit and the second external memory device may be a serial differential interface having a high speed. Furthermore, the serial differential interface having a high speed may be a serial ATA, USB or IEEE 1394 interface. In addition, the boot logic unit may be connected to the CPU core, and configured to suspend an operation of the CPU core and cancel the suspended mode of the CPU core, based on, for example, a HOLD signal controlling the CPU core.

According to further embodiments of the present invention, a booting system includes a central processing unit (CPU) core, a system bus connected to the CPU core, a main memory connected to the CPU core through the system bus, a boot loader memory device connected to the CPU core through the system bus and storing a boot loader program to be executed by the CPU core, an external memory device storing codes and data of an operating system and an application program, and an external interface unit transferring the codes and data of the operating system and the application program from the external memory device to the main memory, in which the external interface unit may be controlled by the boot loader program.

In further embodiments of the present invention, the CPU core, the boot loader memory device, the boot logic unit and the external interface unit may be an integrated system-on-chip. The boot loader memory device may include a read-only memory (ROM). The external memory device may include one of a hard disk and a flash memory device. In addition, an interface between the external interface unit and the external memory device may be a serial differential interface having a high speed. Furthermore, the serial differential interface having a high speed may be one of serial ATA, USB and IEEE 1394 interfaces.

Further embodiments of the present invention provide a method of booting a system. The method includes transferring a boot loader program from a first external memory device to a boot loader memory device, executing the boot loader program transferred to the boot loader memory device, and transferring codes and data of an operating system and applications from a second external memory device to a main memory according to the boot loader program executed by the CPU core. The method may further comprise suspending an operation of the CPU core before transferring the boot loader program from the first external memory device to the boot loader memory device. In addition, the method may further comprise canceling the suspended mode of the CPU core before transferring the boot loader program from the first external memory device to the boot loader memory device.

### BRIEF DESCRIPTION OF THE DRAWINGS

FIG. 1 is a block diagram illustrating a conventional booting system using a flash memory device;

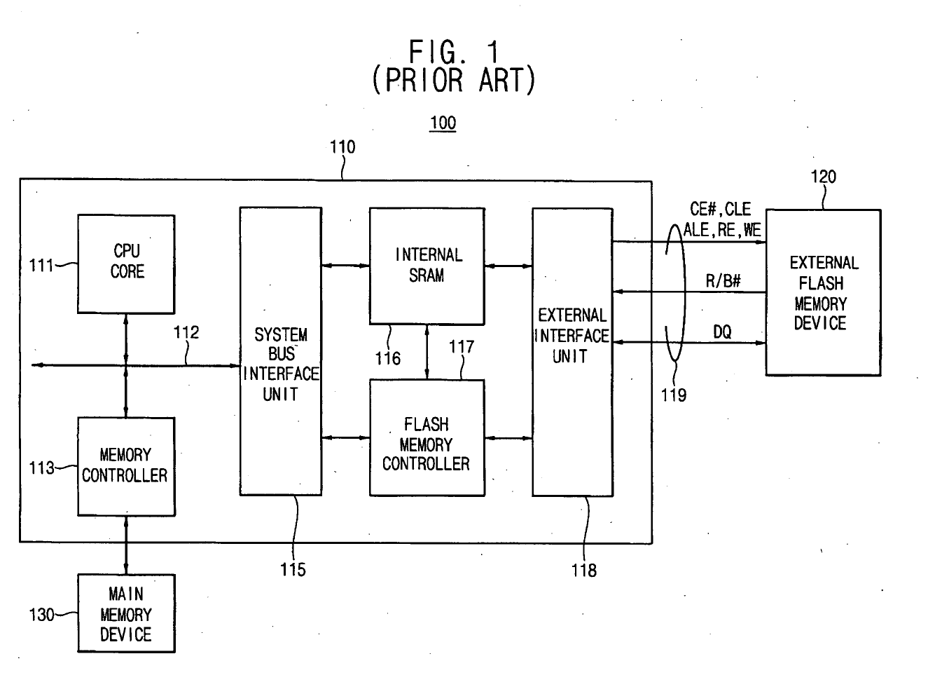

FIG. 2 is a block diagram illustrating a booting system according to an example embodiment of the present invention;

FIG. 3 is a flowchart illustrating a method of operating a booting system according to an example embodiment of the present invention; and

FIG. 4 is a block diagram illustrating a booting system according to another example embodiment of the present invention.

### DESCRIPTION OF THE EXAMPLE EMBODIMENTS

Specific exemplary embodiments of the invention now will be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “includes,” “including” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that although the terms first and second are used herein to describe various elements, these elements should not be limited by these terms. These terms are only used to distinguish one element from another element. Thus, a first item could be termed a second item, and similarly, a second item may be termed a first item without departing from the teachings of the present invention. As used herein, the term “and/or” includes any and all combinations of one or more of the associated listed items. The symbol “/” may also used as a shorthand notation for “and/or”.

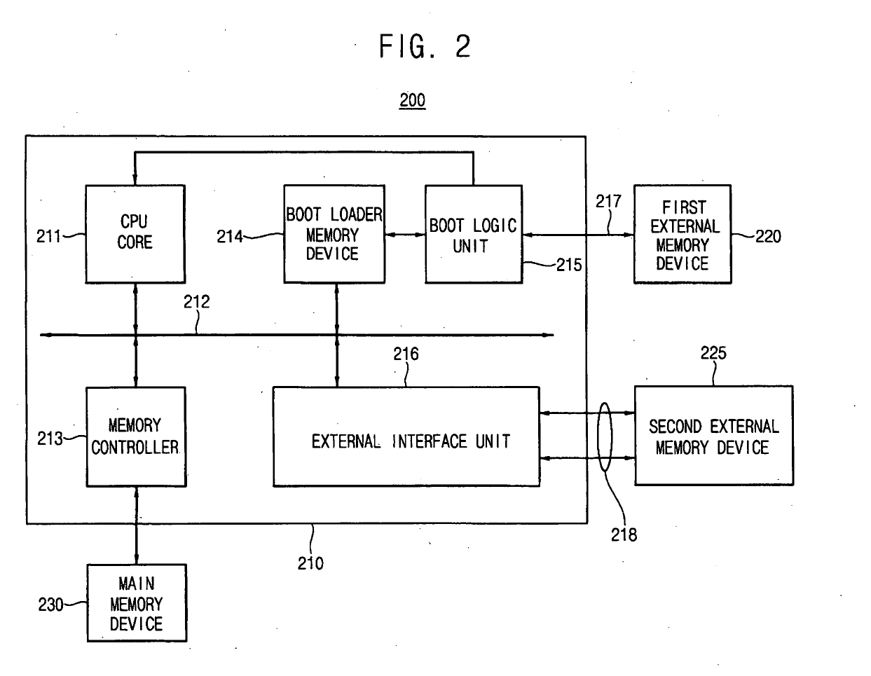

FIG. 2 is a block diagram illustrating a booting system according to an example embodiment of the present invention.

Referring to FIG. 2, the booting system 200 includes a central processing unit (CPU) core 211, a system bus 212 coupled to the CPU core 211 and various peripheral devices, a memory controller 213, a boot loader memory device 214, a boot logic unit 215, an external interface unit 216, a first external memory device 220, a second external memory device 225 and a main memory device 230.

In a case of a portable system such as a personal digital assistant (PDA), the CPU core 211, the system bus 212, the memory controller 213, the boot loader memory device 214, the boot logic unit 215 and the external interface unit 216 may be integrated into a system-on-chip 210.

A boot loader program is stored in the first memory device 220. The first external memory device 220 may include a serial electrically erasable programmable read-only memory (EEPROM).

When the first external memory device 220 includes the EEPROM, a serial interface standard may be employed as a first external interface 217 between the first external memory device 220 and the boot logic unit 215, to reduce a number of input and output pins thereof. It is noted that, when a serial interface is selected as the first external interface 217, the boot logic unit 215 has to include an interface processing unit corresponding to the serial interface standard.

The serial interface may be, for example, an Intelligent Interface Controller (I²C) or a serial peripheral interface (SPI) that are widely adopted.

The I²C interface standard uses one clock signal line and one data line. I²C may be implemented using a simple protocol. SPI is a serial interface standard having a clock signal line, a strobe signal line and one or two data lines. Therefore, the first external interface 217 between the first external memory device 220 and the boot logic unit 215 may be selectively determined depending on a configuration of the first external memory device 220 and the boot logic unit 215.

The boot loader memory device 214 may include a static RAM (SRAM) having a higher access speed. The boot loader memory device 214 is mapped in an address space of the CPU core 211 so that the CPU core 211 may access the boot loader memory device 214 through the system bus 212.

Using the first external memory device 220 and the first external interface 217 configured as above described, the boot logic unit 215 is used to transfer the boot loader program stored in the first external memory device 220 to the boot loader memory device 214 when the system is powered on or reset.

Therefore, while the boot logic unit 215 transfers the boot loader program stored in the first external memory device 220 to the boot loader memory device 214 when the system is powered on or reset, an access of the CPU core 211 to the boot loader memory device 214 has to be limited.

When operation of transferring the boot loader program stored in the first external memory device 220 to the boot loader memory device 214 is finished, the boot logic unit 215 may allow the CPU core 211 to access to the boot loader memory device 214 so that the boot loader program transferred to the boot loader memory device 214 is performed by the CPU core 211.

A method of suspending the operation of the CPU core 211 may vary according to an employed CPU core. For example, a HOLD signal to the CPU core may be used to temporarily suspend the operation of the CPU core 211 or cancel the suspended mode of the CPU core 211.

The second external memory device 225 is a storage device for storing codes and data for an operating system and application programs.

Therefore, it is preferable that the second external memory device 225 has a large capacity and lower unit cost per capacity compared with the first external memory device 220. For example, the second external memory device 225 may be a hard disk, a flash memory device having a large capacity, etc.

The external interface unit 216 is controlled by the boot loader program transferred to the boot loader memory device 214 and controls an interface with the second memory device 225.

A high-speed serial differential transmission interface may be employed as the second external interface 218 between the external interface unit 216 and the second external memory device 225. As described above, the CPU core 211, the system bus 212, the memory controller 213, the boot loader memory device 214, the boot logic unit 215 and the external interface unit 216 can be integrated into a system-on-chip 210, because the number of the input and output pins for interfacing with an external device of the chip 210 is required to be reduced.

Therefore, as the second external interface 218 that interfaces between the external interface unit 216 and the second external memory device 225, for example, an interface standard such as a Serial Advanced Technology Attachment (SATA), a Universal Serial Bus (USB), or IEEE 1394 may be employed.

The SATA standard supports a transfer rate of approximately 150 MB/s in the first generation, approximately 300 MB/s in the second generation and approximately 600 MB/s in the third generation. The SATA standard is constructed to include four input and output signal lines. When the SATA standard is employed, the number of the input and output pins may be significantly reduced and the booting time may also be reduced.

The USB standard supports a transfer rate of approximately 60 MB/s for USB 2.0 and is constructed to include only two input and output signal lines. In the same way as the SATA standard, the USB standard may largely reduce the number of the input and output pins and the entire booting time.

IEEE 1394 is a serial interface standard to interconnect digital devices and electrical devices that require a higher data rate. An IEEE 1394a standard may support a transfer rate of approximately 400 MBps, and an IEEE 1394b standard may support a transfer rate of approximately 800 MBps. Therefore, similar to the SATA standard and the USB standard, the IEEE 1394 standard may reduce the number of the input and output pins and the booting time.

According to the selected interface standard of the second external interface 218 that interfaces between the external interface unit 216 and the second external memory device 225, the contents of the boot loader program stored in the first external memory device 220 may vary, as follows.

When the SATA standard is employed for the second external interface 218, a program code for supporting the SATA standard may be included in the boot loader program. Similarly, when the USB standard is employed for the second external interface 218, a program code for supporting the USB standard may be included in the boot loader program. Therefore, when the external interface unit 216 is mounted on the system-on-chip as a functional block, the boot loader program that is configured to control the external interface unit 216 may be flexibly modified according to a type of the function block corresponding to the external interface unit 216.

When a re-programmable serial EEPROM is used for the first external memory device 220, the boot loader program may be easily debugged and upgraded. In addition, while developing an upgrade of a system, the boot load program to be stored in the first external memory device 220 may be replaced with a test program for testing the functional blocks integrated on a system-on-chip.

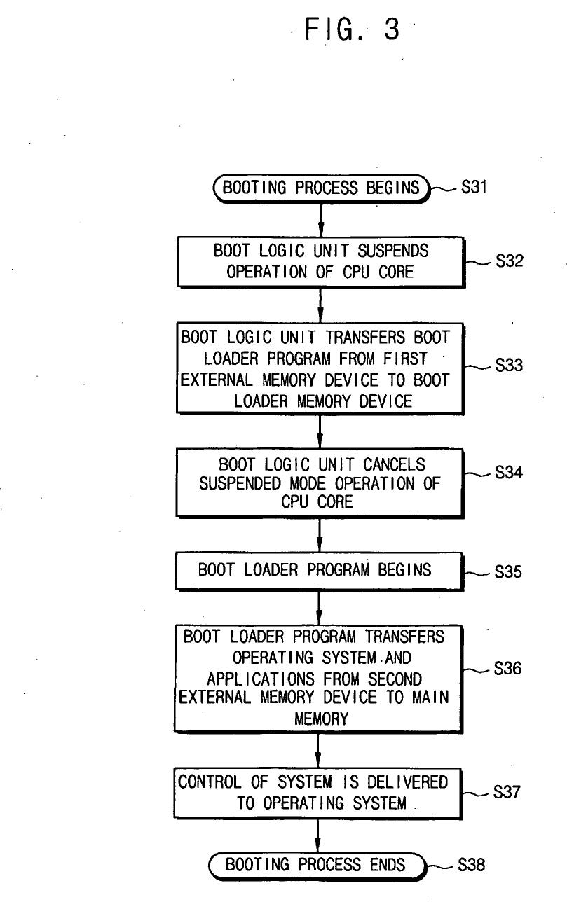

FIG. 3 is a flowchart illustrating a method of operating a booting system according to an example embodiment of the present invention.

A booting process of the booting system according to an example embodiment of the present invention begins in step S31 when the system is powered on or in response to a predetermined reset signal.

Before transferring the boot loader program stored in the first external memory device 220 to the boot loader program, the operation of the CPU core 211 is suspended by the boot logic unit 215 in step S32. As described above, the access of the CPU core 211 to the boot loader memory device 214 needs to be prevented during the transfer of the boot loader program from the first external memory device 220 to the boot loader memory device 214.

In step S33, the boot loader program stored in the first external memory device 220 is transferred to the boot loader memory device 214 by the boot logic unit 215.

When the size of the boot loader program is excessively large, a time required to transfer the boot loader program may be greatly increased. In this case, the transfer time may be further increased because of limitations of a reading speed of the first external memory device 220, which is the serial EEPROM in typical applications, and the transfer rate of the first external interface 217, which may be compatible with a serial interface standard.

However, while the size of the boot loader program is generally limited within about 4 kilobytes, the operating system and applications have a size ranging up to tens or hundreds of megabytes. Therefore, a ratio of the transfer time of the boot loader program to the entire booting time is remarkably small. Consequently, the limitations with respect to transferring the boot loader program may be acceptable.

The boot loader memory device 214 needs to be mapped in an address space of the CPU core 211 so that the CPU core 211 may access the boot loader memory device 214 over the system bus 212. Therefore, after the boot loader program is reproduced on the boot loader memory device 214 by the boot logic unit 215, the boot logic unit 215 cancels the suspended mode of the CPU core 211 in step S34. When the suspended mode of the CPU core 211 is canceled, the boot loader program transferred to the boot loader memory device 214 is performed by the CPU core 211 in step S35.

In step S36, the boot loader program is executed to operate the external interface unit 216 and transfer the codes and data of an operating system and application programs stored in the second external memory device 225 to the main memory device 230.

When the codes and data of the operating system and the application programs are completely transferred to the main memory device 230, control of the system is delivered to the operating system in step S37. More specifically, the boot loader program modifies a program counter of the CPU core 211 to a start address of the operating system so that the system may be controlled by the operating system. The computer system then controls the operating system, and thus, the booting operation is ended in step S38.

In another exemplary embodiment of the invention, the first external memory device 220 and the boot logic unit 215 may not be included in the booting system 200 and read-only memory (ROM) may be employed as the boot loader memory device 214. This may reduce complexity of a configuration related to the first external memory device 220 and the boot logic unit 215. Costs for implementing a system may be reduced in the above case of using the ROM, while the boot loader program may be easily modified and upgraded by using the re-programmable serial EEPROM memory device as the first external memory device 220.

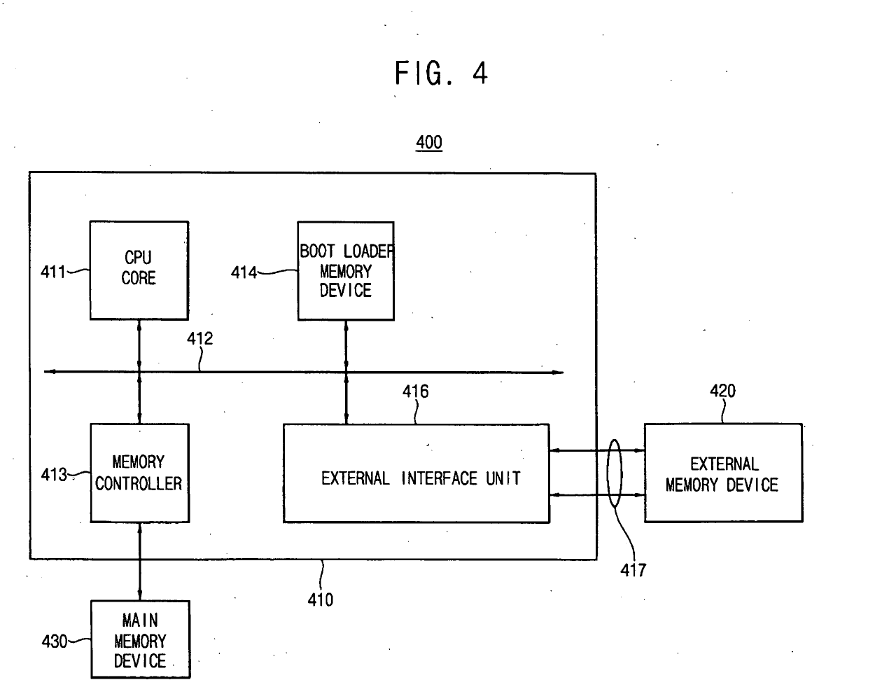

FIG. 4 is a block diagram illustrating a booting system according to another example embodiment of the present invention.

Referring to FIG. 4, a booting system 400 includes a CPU core 411, a system bus 412 coupled to the CPU core 411 and various peripheral devices, a memory controller 413, a boot loader memory device 414, an external interface unit 416, an external memory device 420 and a main memory device 430.

Similar to the booting system 200 of FIG. 2, when the booting system is incorporated in a portable system such as personal digital assistant (PDA), the CPU core 411, the system bus 412, the memory controller 413, the boot loader memory device 414 and the external interface unit 416 may be typically integrated to a system-on-chip 410.

A boot loader program is stored in the boot loader memory device 414. Unlike the booting system 200 in FIG. 2, the boot loader memory device may include a ROM. As described above, using the ROM as the boot loader memory device 414, the boot logic unit 215 and the boot loader memory device 214 that generally corresponds to a static RAM may be excluded in the booting system 400.

As described with regard to the booting system 200 of FIG. 2, the boot loader memory device 414 may be mapped in the address space of the CPU core 411 so that the CPU core 411 may access the boot loader memory device 414 through the system bus 412.

The external memory device 420 is a storage device for storing codes and data of an operating system and application programs. For example, the external memory device 420 may be a hard disk, a flash memory device having a large capacity, etc. as with the second external memory device 225 of FIG. 2.

The external interface unit 416 is controlled by the boot loader program stored in the boot loader memory device 414 and controls an interface with the external memory device 420. A high-speed serial differential transmission interface standard may be used for an external interface 417 between the external interface unit 416 and the external memory device 420. For example, an interface standard such as a Serial Advanced Technology Attachment (SATA), a Universal Serial Bus (USB), IEEE 1394, etc. may be employed as the interface 417 as already described with reference to FIG. 2.

Similar to the booting system 200 of FIG. 2, the boot loader program stored in the boot loader memory device 414 may include a code for controlling the external interface unit 416 corresponding to the standard of the external interface 417 between the external interface unit 416 and the external memory device 420.

Thus, according to the example embodiments of the present invention, the boot loader program is stored in the first external memory device. In addition, the codes and data of an operating system and the codes and data of application programs are stored in the separate second external memory device. Owing to the separation of the memory devices, the high-speed serial differential transmission interface standard may be flexibly employed for interfacing with the second external memory device. Therefore, a booting speed may be increased in implementing a system-on-chip of a portable system such as a PDA. Furthermore, the number of input and output pins may be reduced and power consumption may also be reduced.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A booting system comprising:
a central processing unit (CPU) core;
a system bus coupled to the CPU core;
a main memory coupled to the CPU core through the system bus;
a boot loader memory device coupled to the CPU core through the system bus;
a first external memory device for storing a boot loader program;
a boot logic unit configured to transfer the boot loader program from the first external memory device to the boot loader memory device, the boot loader program being executed by the CPU core;
a second external memory device for storing codes and data of an operating system and an application program; and
an external interface unit configured to transfer the codes and the data of the operating system and the application program from the second external memory device to the main memory, the external interface unit being controlled by the boot loader program.

2. The booting system of claim 1, wherein the CPU core, the boot loader memory device, the boot logic unit and the external interface unit are integrated into a system-on-chip.

3. The booting system of claim 1, wherein the first external memory device includes a serial electrically erasable programmable read-only memory (EEPROM).

4. The booting system of claim 3, wherein an interface between the first external memory device and the boot logic unit includes one of an Intelligent Interface Controller (I²C) and a Serial Peripheral Interface (SPI).

5. The booting system of claim 1, wherein the second external memory device includes one of a hard disk and a flash memory device.

6. The booting system of claim 1, wherein an interface between the external interface unit and the second external memory device corresponds to a serial differential interface having a high speed.

7. The booting system of claim 6, wherein the serial differential interface having a high speed corresponds to one of Serial Advanced Technology Attachment (ATA), USB and IEEE 1394 interfaces.

8. The booting system of claim 1, wherein the boot logic unit suspends an operation of the CPU core and cancels the suspended mode of the CPU core, the boot logic unit being connected to the CPU core.

9. The booting system of claim 8, wherein the boot logic unit suspends an operation of the CPU core and cancels the suspended mode of the CPU core based on a HOLD signal controlling the CPU core.

10. A booting system comprising:
a central processing unit (CPU) core;
a system bus coupled to the CPU core;
a main memory coupled to the CPU core through the system bus;
a boot loader memory device coupled to the CPU core through the system bus, the boot loader memory device storing a boot loader program to be executed by the CPU core;
an external memory device for storing codes and data of an operating system and an application program; and
an external interface unit configured to transfer the codes and data of the operating system and the application program from the external memory device to the main memory, the external interface unit being controlled by the boot loader program.

11. The booting system of claim 10, wherein the CPU core, the boot loader memory device, the boot logic unit and the external interface unit are integrated into a system-on-chip.

12. The booting system of claim 10, wherein the boot loader memory device includes a read-only memory (ROM).

13. The booting system of claim 10, wherein the external memory device includes one of a hard disk and a flash memory device.

14. The booting system of claim 10, wherein an interface between the external interface unit and the external memory device corresponds to a serial differential interface having a high speed.

15. The booting system of claim 14, wherein the serial differential interface having a high speed corresponds to one of Serial Advanced Technology Attachment (ATA), USB and IEEE 1394 interfaces.

16. A method of booting a computer system comprising:
transferring a boot loader program from a first external memory device to a boot loader memory device;
executing the boot loader program, which is transferred to the boot loader memory device;
transferring codes and data of an operating system and an application from a second external memory device to a main memory by executing the boot loader program, the boot loader program being executed by the CPU core.

17. The method of claim 16, further comprising suspending an operation of the CPU core before transferring the boot loader program from the first external memory device to the boot loader memory device.

18. The method of claim 17, further comprising canceling a suspended mode of the CPU core before transferring the boot loader program from the first external memory device to the boot loader memory device.

19. The method of claim 16, further comprising transferring control of said computer system to the operating system after transferring operating system codes and data to the main memory.
